(19) United States
(12) Patent Application Publication
(10) Pub. No.: US 2022/0412707 A1
(43) Pub. Date: Dec. 29, 2022

(54) NON-LETHAL DISTRACTION AND GLASS, METHOD OF ENTRY DEVICES

(71) Applicant: Typhon Group Limited, Salisbury (GB)

(72) Inventor: Stephen ROGERS, Salisbury (GB)

(21) Appl. No.: 17/597,773

(22) PCT Filed: Jun. 10, 2019
(86) PCT No.: PCT/IB2019/054811

§ 371 Date: Jan. 21, 2022

(30) Foreign Application Priority Data
Apr. 17, 2019 (GB) 1905418.8

(51) Int. Cl. F42B 12/42; F41H 13/00

(52) U.S. Cl. CPC F42B 12/42; F41H 13/0087; F41H 13/0081

(57) ABSTRACT

When Law Enforcement and Military teams are entering a premises or hostile environment, they often use a distraction device to create temporary confusion and disorientation of target individuals. Conventional flash-bangs carry significant risk of collateral damage through fire, smoke inhalation, high temperature burns and fragmentation. The invention proposes a modular, reloadable, non-lethal solution offering various form factors. They significantly reduce/eliminate collateral damage. The devices utilise the same principle—single or multiple machined port(s), plus pyrotechnic ignitor. Gas pressure expanding inside each port ruptures a membrane. The release of this pressure creates a sound impulse. For GMOE (Glass method of Entry) Hand-held, Wired & RF initiated devices, gas pressure created by the ignitor functioning drives a captive hardened steel punch forward. The punch ruptures a membrane on the front face of the device breaking any glass it is in contact with.

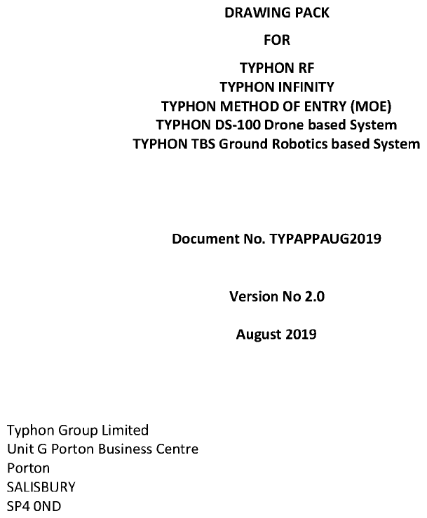

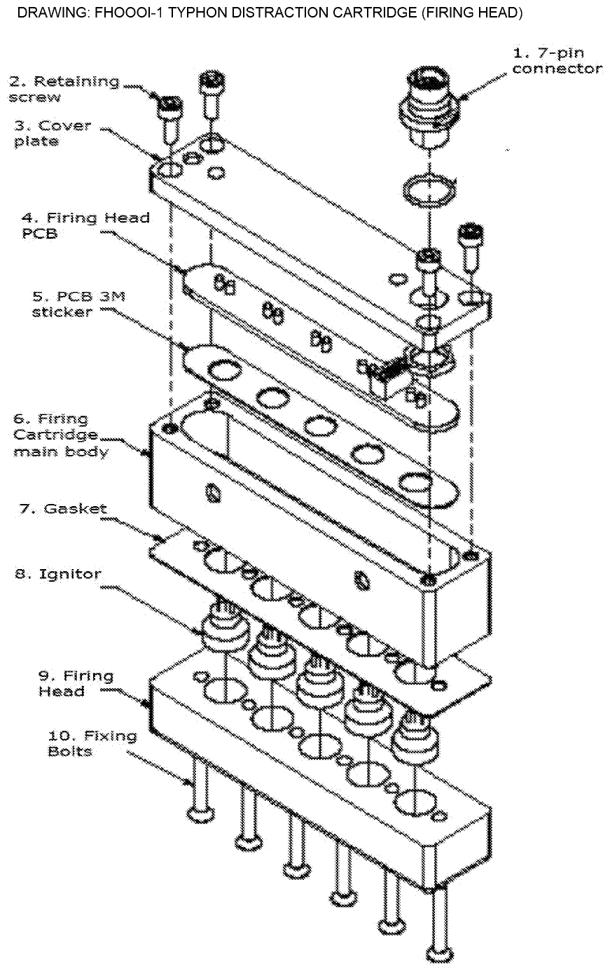

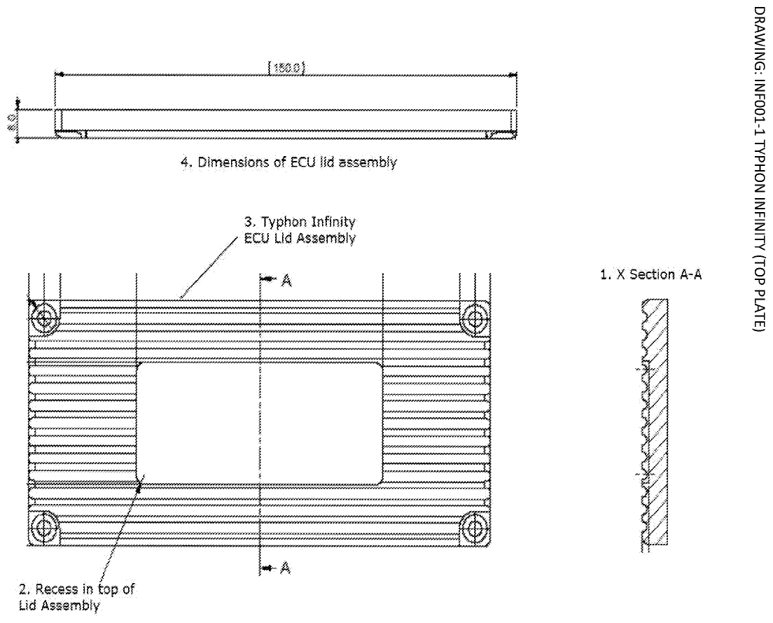

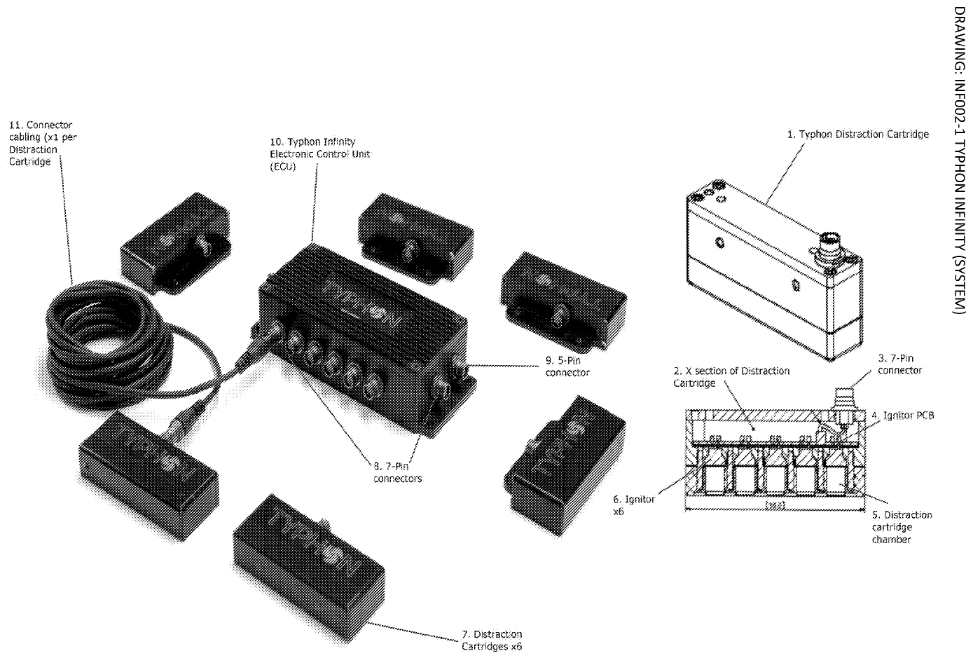

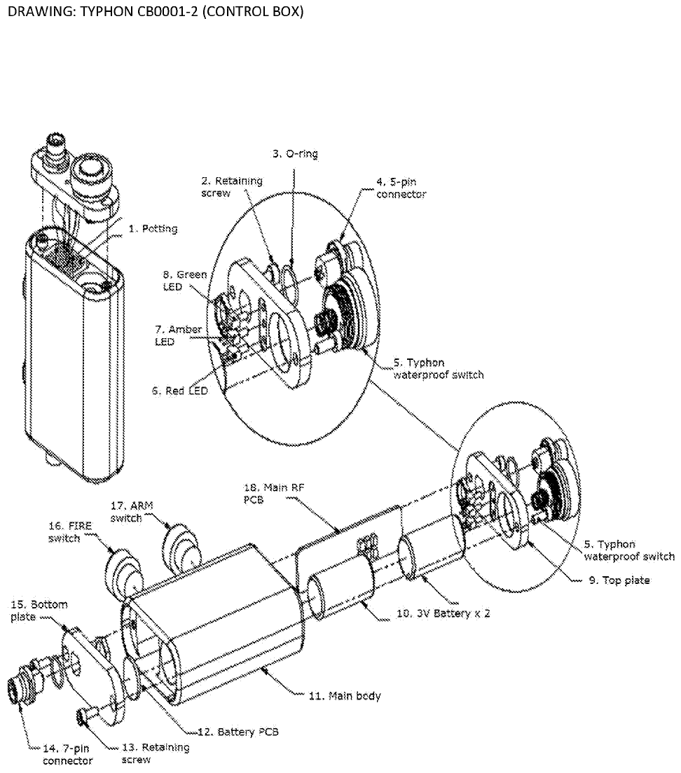

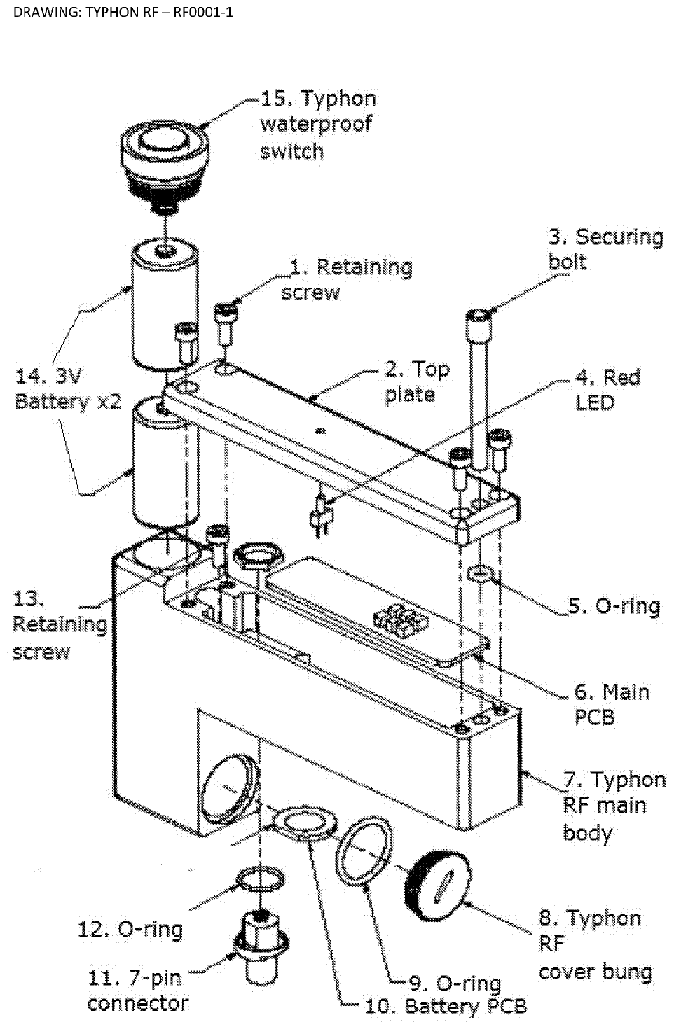

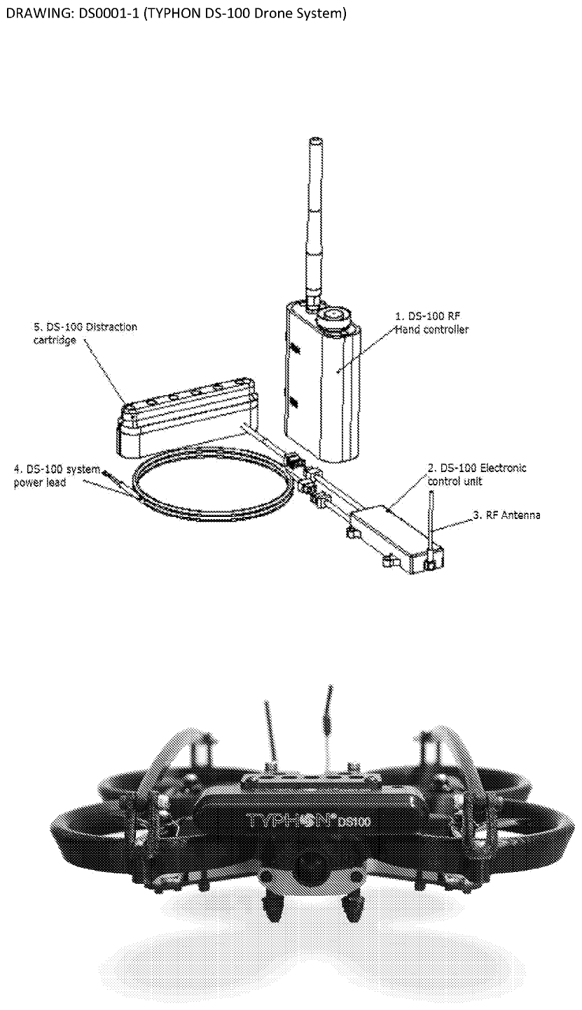

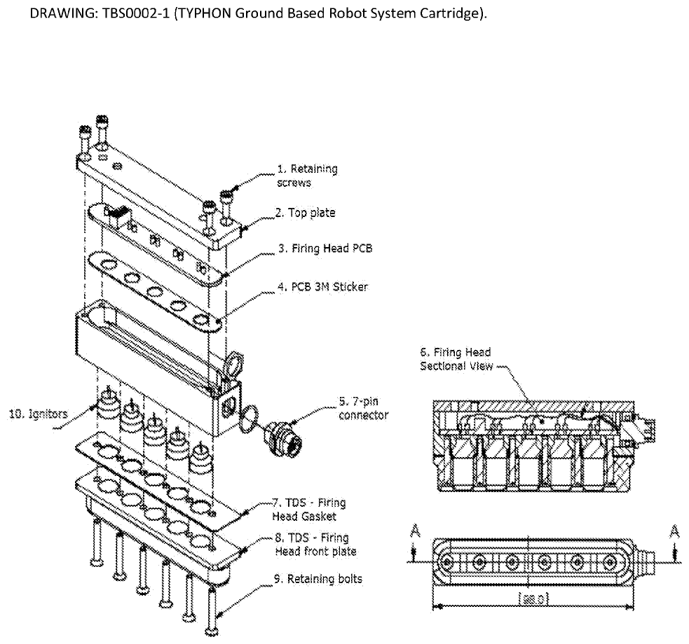

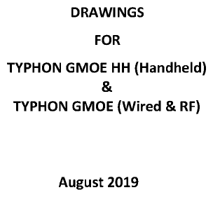

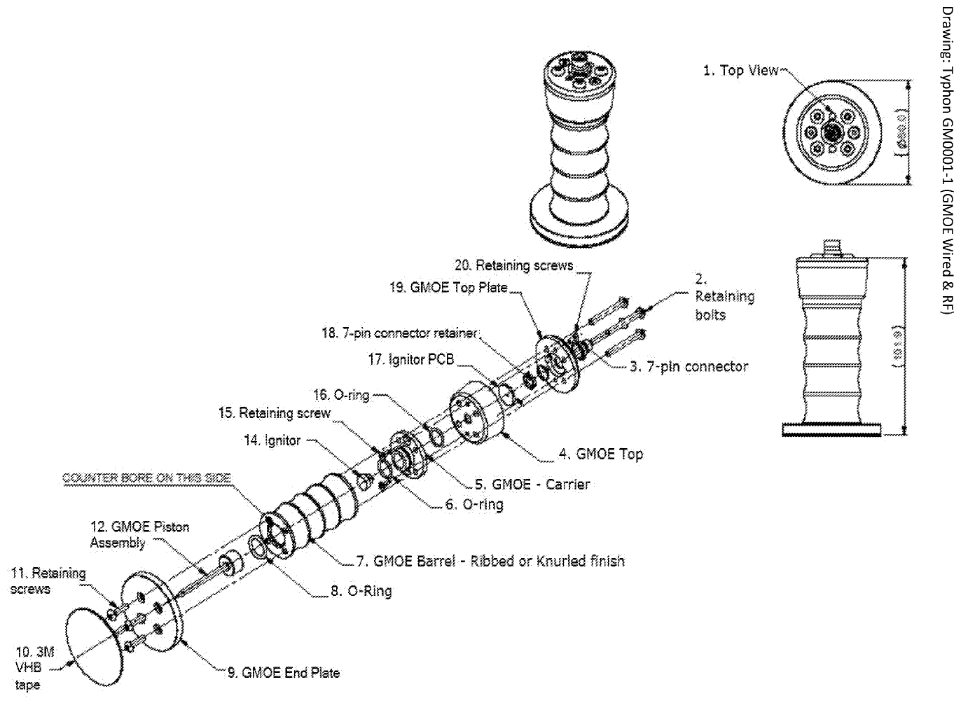

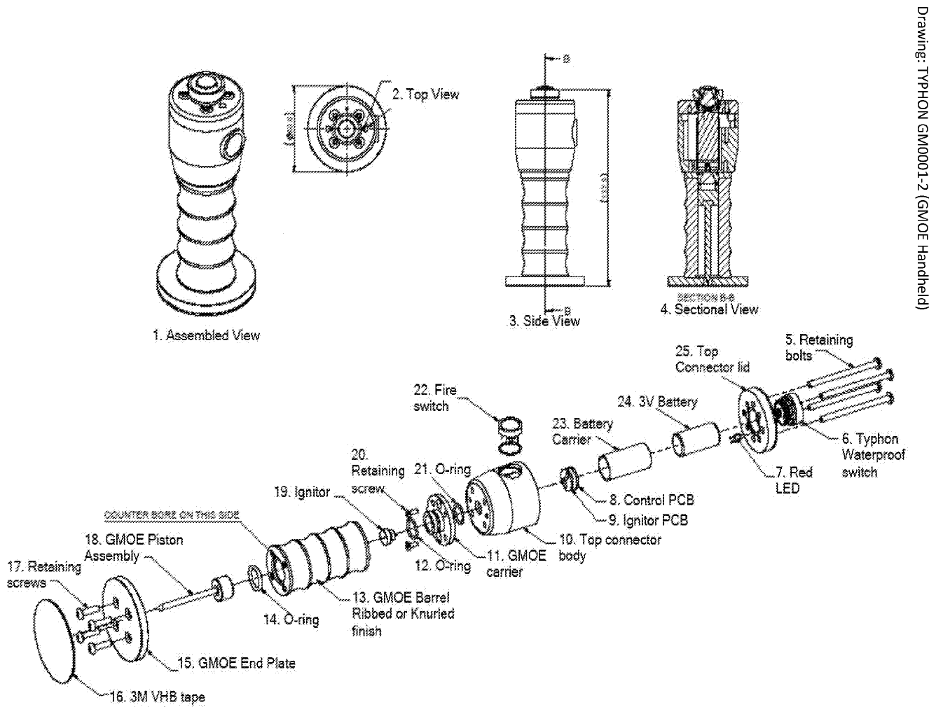

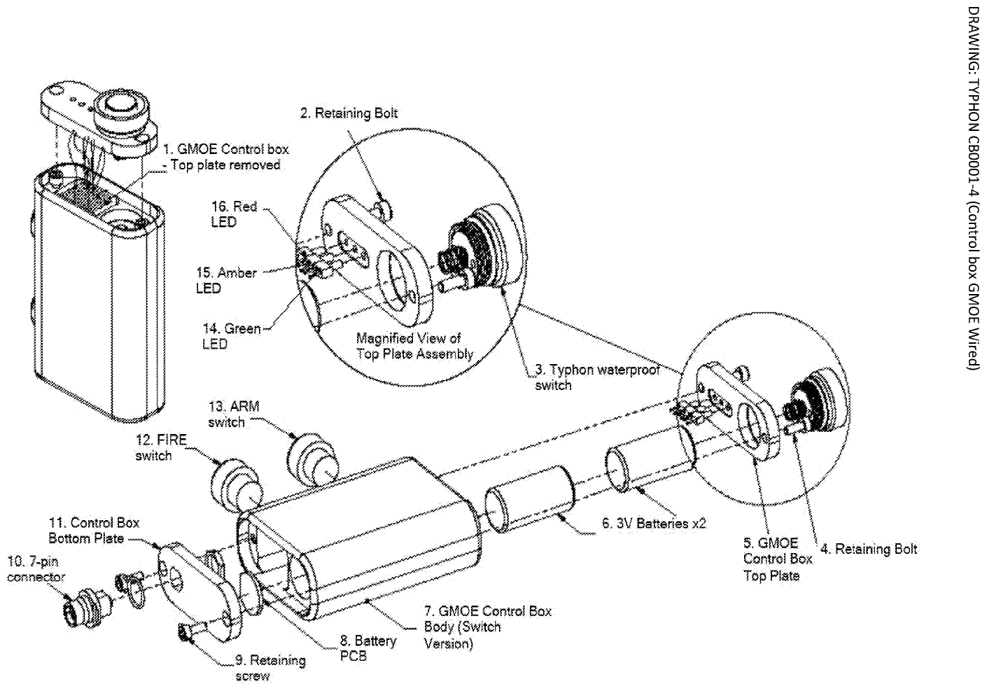

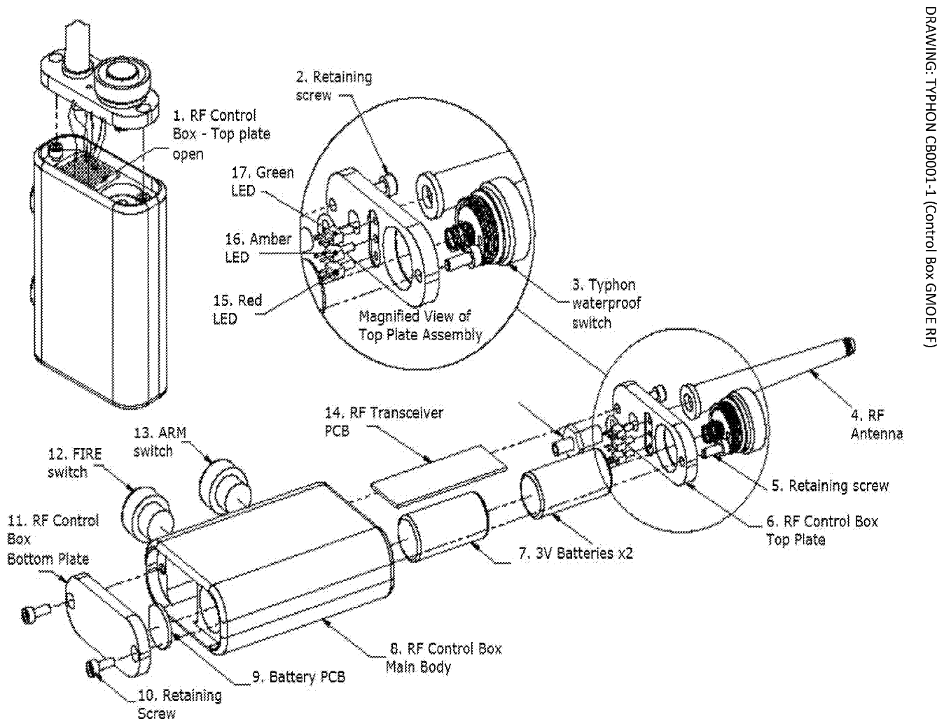

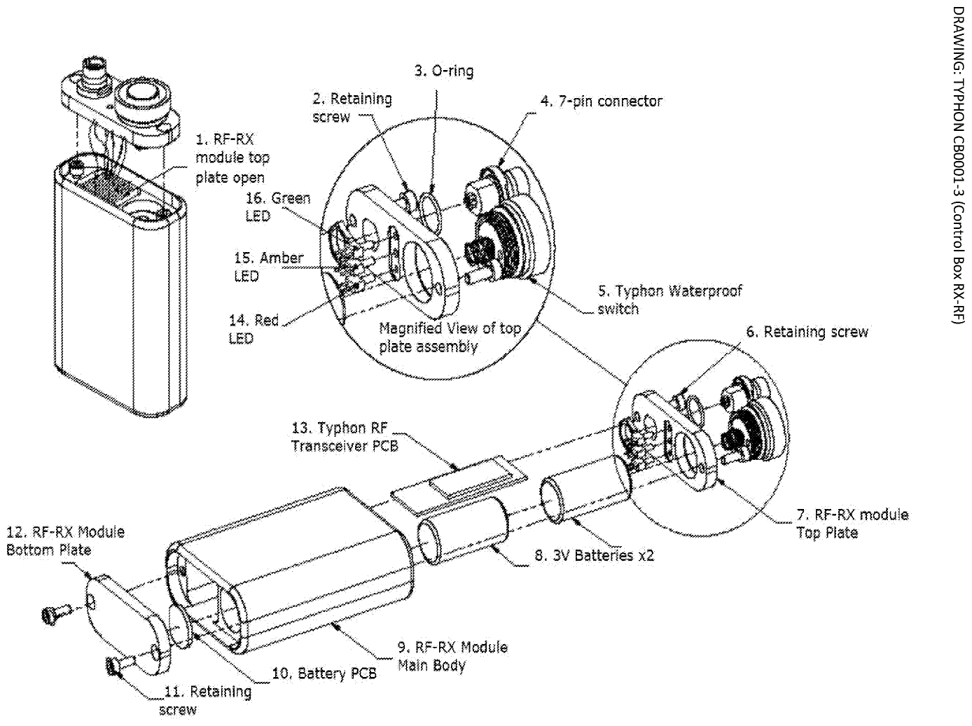

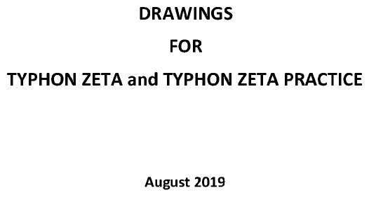

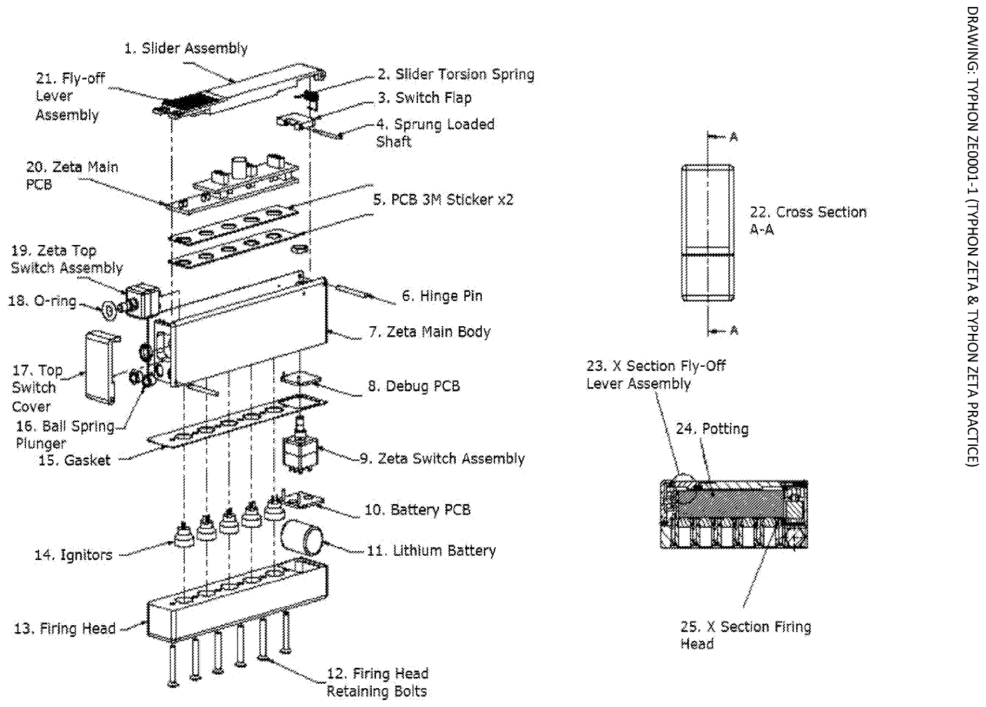

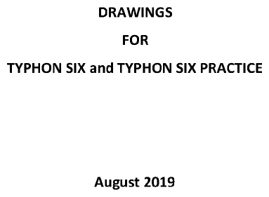

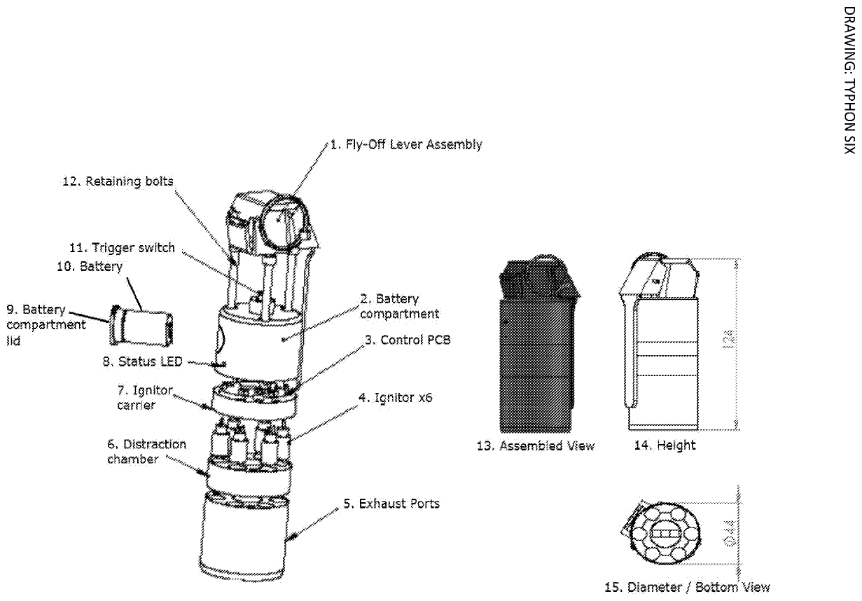

This document describes Typhon Infinity, Typhon MOE, Typhon RF, Typhon DS-100 and Typhon TBS. These devices are electronically controlled, pyrotechnic distraction systems. They are configured as follows;
Typhon Infinity:—Infinity is a modular electronically controlled distraction system with the capacity to attach over six Typhon Distraction Cartridges. Each cartridge provides five events with minimal flash, smoke and fragmentation.
Typhon MOE:—MOE is a wire controlled electronic distraction system that utilises one Typhon Distraction Cartridge, which provides five events with minimal flash, smoke and fragmentation.
Typhon RF:—RF is a remotely controlled electronic distraction device which provides five events with minimal flash, smoke and fragmentation
Typhon DS-100:—DS-100 is a drone mounted, remotely controlled electronic distraction device which provides five events with minimal flash, smoke and fragmentation
Typhon TBS:—TBS is a ground-based robot mounted, remotely controlled electronic distraction device which provides five events with minimal flash, smoke and fragmentation

Each of the Typhon systems listed above utilises the same five event, reloadable Typhon Distraction Cartridge. They are single use, modular, reloadable items and contain established energetic materials.

Typhon Infinity, MOE and RF have been designed and developed by Typhon Group Ltd to fill a niche role for Law Enforcement, Military & Government assault teams. They provide a distraction capability that has a very low inherent fire and fragmentation risk; hence they can be used in high value target assets and/or where there is a significant fire risk. There is a practice version that has a reduced sound output for training purposes.

Typhon Infinity, MOE and RF utilise the same reloadable Typhon Distraction Cartridge to create temporary distraction and disorientation by emitting five sound impulses. The Typhon Distraction Cartridge has been optimised to have a low Net Explosive Quantity (NEQ). This feature significantly reduces the inherent fire risk compared to other distraction devices.

The operational version of the Typhon Distraction Cartridge has a sound output of 170 dB when measured at 2 metres. There is also a practice version of the Typhon Distraction Cartridge. This is identical in size and appearance to the operational versions and utilises the same technology, however it has a reduced sound output of 140 dB when measured at 2 metres.

An important safety feature of Typhon Infinity, MOE and RF is that the effect they produce is not considered to cause any long-term injuries to the health of hostages or the CT assault team.

### Technical Details

The Typhon Distraction Cartridge utilises a software controlled electronic circuit. The Typhon Distraction Cartridge has 5 machined ports each containing an electrically initiated pyrotechnic ignitor. Each ignitor receives a power pulse from the main circuit, which functions the ignitor. The gas pressure created by the ignitor functioning expands inside each port until it ruptures an aluminium membrane on the front face of the device. The release of this gas pressure creates a sound impulse of 170 dB.

The Typhon Distraction Cartridge receives a command signal from the Command Control Unit (CCU). This applies battery power to the firing circuit and each of the five electro-pyrotechnic fuzes are pre-programmed to initiate at specific time intervals. The action of each fuze firing is to generate gas pressure in each machined port. The gas pressure increases until it ruptures an aluminium membrane and hence creates a sound impulse. Once the device has been functioned it goes into a lock out mode to render it safe, in case any of the electro-pyrotechnic fuzes have failed to function.

The Typhon Distraction Cartridge has End-User programmable functionality that enables the function delay time of the sound impulses to be adjusted to suit the User's preference.

A variant of the Typhon Distraction Cartridge can also be configured to deliver a temporary incapacitation effect in addition to the distraction. To achieve this, a pressed pellet of 0-Chlorobenzylidene Malononitrile (CS) is inserted into each of the five ports. The CS cartridge is prevented from initiation on a standard device and requires relevant authority and specific factory programming to enable initiation.

The Typhon Distraction Cartridge can be loaded with a fire-retardant powder to further reduce the flash signature and hence lower the flammability risk of the device.

Unlike conventional devices the Typhon Distraction Cartridge can be returned to the factory for testing, reloading and re-issue once initiated.

### Initiation

Typhon Infinity, MOE and RF utilise a command link via RF. This feature allows for the quick deployment within a 1 km line of sight from the controller for activation and monitoring.

The system comprises of a RF Transmitter Module manufactured from Aluminium Alloy W6082-T6 (BS EN755) and black anodised. The transmitter module has outside dimensions of 124 mm×30 mm×22 mm and a weight of 120 g including the battery. The operating frequency range is 868 MHz or 915 MHz using the ISM bands with an effective range of transmission is a maximum of 5 km line of sight.

Typhon Infinity can attach multiple, reloadable Typhon Distraction Cartridges. All Cartridges are hard wired to the Control Unit and initiated via a fixed control wire or RF signal. Designed primarily for vehicle deployments, Typhon Infinity provides a flexible method of protecting high value assets or providing a perimeter defence.

The Typhon RF system utilises a Single Typhon Distraction module. Once the Typhon RF Transmitter module is switched on, the Distraction System constantly listens for a trigger signal. Once this is received the Distraction System initiates the five events which can be pre-programmed to mirror a specific pattern or timing profile as required. Once the device has been used it enters a safe inert state for retrieval and recharge. Unlimited systems can be initiated with one hand controller, and with programming, each system can initiate simultaneously or with designed tactical delays.

The Typhon MOE system utilises a single reloadable Typhon Distraction Cartridge that is hard wired to a hand operated firing unit.

Integration with Ground Based Robotics Systems

Typhon Group Ltd have designed a bespoke system that enables Typhon RF to integrate with various Third-Party Ground Based remote controlled vehicles (RCV). The system comprises a mounting cradle machined from aluminium alloy. This cradle is secured directly to the RCV and incorporates the RF receiver. A Typhon RF reloadable Distraction Cartridge is then attached and secured directly to the cradle.

This system enables the system operator to remotely deliver distraction and incapacitation effects to a target stronghold.

Integration with Drone/UAS (Unmanned Aerial Systems) Systems

Typhon Group Ltd have developed a lightweight (under 100 grams), version of the Typhon RF distraction head—called DS-100. This lightweight version can be integrated with various Drone Systems from third party manufacturers. This system enables the operator to deliver distraction and incapacitation effects remotely by air or ground to a target stronghold.

### Typhon Infinity

The Typhon Infinity system utilises a Central Control Unit (CCU) to initiate up to six reloadable Typhon Distraction Cartridges. The system can be either vehicle mounted for VIP/Operator protection at unauthorised vehicle checkpoints, or premises mounted to provide distraction allowing principles time to re-locate to a secure area.

### Novel Design Features of Typhon RF

The Typhon RF utilises a pyrotechnic ignitor to rupture an aluminium membrane to create a sound impulse of around 170 dB when measured at 2 m.

The pyrotechnic ignitors are controlled by End-User programmable electronic circuitry. This circuitry allows Typhon systems to be accurately programmed down to 1 millisecond. This programming is both accurate and consistent.

Typhon RF can be used with the Typhon bespoke mounting system to integrate with ground based robotic systems. The pairing of Typhon RF and ground based robot system can then be used to deliver distraction and incapacitation effects remotely.

The Typhon DS-100 Drone versions of the Typhon RF can be used by Law Enforcement, Government and Military agencies in conjunction with third party drone/UAS (Unmanned Aerial System), systems to deliver distraction and incapacitation effects remotely by air or ground. Typhon Group Ltd manufactures bespoke fitting kits to enable fitment of the Typhon DS-100 drone system to other third-party drone/UAS systems.

### Typhon Distraction Cartridge Technical Drawing Pack

The technical drawing pack for the Typhon Distraction Cartridge is enclosed. Typhon drawing number TYPHON FH0001-1 applies (Page 2 of Drawing Pack document).

### Typhon Infinity Technical Drawing Pack

The technical drawing pack for Typhon Infinity is enclosed. Typhon drawing number TYPHON INF001-1 & TYPHON INF002-1 apply (Page 3 & 4 of Drawing Pack document).

### Typhon MOE Technical Drawing Pack

The technical drawing pack for Typhon MOE is enclosed. Typhon drawing number TYPHON CB0001-2 & TYPHON FH0001-1 applies (Page 5 & 1 of Drawing Pack document).

### Typhon RF Technical Drawing Pack

The technical drawing pack for Typhon RF is enclosed. Typhon drawing number TYPHON RF0001-1 applies (Page 6 of Drawing Pack document).

### Typhon DS-100 Technical Drawing Pack

The technical drawing pack for Typhon DS-100 is enclosed. Typhon drawing number TYPHON DS0001-1 applies (Page 7 of Drawing Pack document).

### Typhon TDS Technical Drawing Pack

The technical drawing pack for Typhon TDS is enclosed. Typhon drawing number TYPHON TBS0002-1 applies (Page 8 of Drawing Pack document).

Description

For

Typhon GMOE HH (Handheld)

&

TYPHON GMOE (Wired & RF)

May 2019

### Introduction

This section of the description describes Typhon GMOE HH (Glass Method of Entry-Handheld) and Typhon GMOE (Glass Method of Entry-Wired & RF) for application purposes. They are both reloadable, pyrotechnic glass-breaking devices. Typhon GMOE HH is a handheld device, Typhon GMOE (Wired & RF), is a pre-positioned device. Both devices utilise the same principle of operation and hardware.

Typhon GMOE HH and Typhon GMOE (Wired & RF) are reloadable, single use items and contain established energetic materials.

Typhon GMOE HH and Typhon GMOE (Wired & RF) are designed to break toughened glass. The devices have been optimised to have a low Net Explosive Quantity (NEQ). This feature significantly reduces the inherent fire risk. An important safety feature of the device is that the effect it produces is not considered to cause any long-term injuries to the health of hostages or the CT assault team.

### Technical Details

Typhon GMOE HH is a handheld device that is designed to break toughened glass. Typhon GMOE HH is manufactured from Aluminium Alloy grade 2011 and has a black anodised finish. It has outside dimensions of diameter 60 mm long by 155 mm long and weighs 350 g. It uses an internal CR123A Lithium battery and is controlled by an internal LPC11U2x microprocessor.

The Typhon GMOE (Wired & RF) systems comprises of a Typhon GMOE that utilises either a RF transmitter/receiver system to command the device or a firing cable and firing box. Typhon GMOE (Wired & RF) has similar external dimensions and energetics as per the Typhon GMOE HH.

### Operation

Typhon GMOE HH is held directly in contact with the target surface by the Operator. GMOE HH is initiated by the Operator simultaneously depressing a push button switch arming switch and a push button firing switch. Typhon GMOE HH utilises the same software controlled electronic circuit incorporating its own power supply as the other Typhon products. Typhon GMOE HH has a single machined port that contains an electrically initiated pyrotechnic ignitor. The ignitor receives a power pulse from the main circuit, which functions the ignitor. The gas pressure created by the ignitor functioning expands inside the port and drives a captive punch forward. The punch ruptures an aluminium membrane on the front face of the device. The gas pressure keeps the plunger fully deployed after initiation.

Typhon GMOE (Wired & RF) systems use the same principle of operation as for the GMOE HH (Para 35 above). GMOE (Wired & RF) is bonded to the target by a self-adhesive pad fixed to the end face of the device. The device is then commanded by either a hard-wired link to the Hand Controller or via Radio Frequency (RF).

### Novel Design Features of Typhon GMOE HH & Typhon GMOE

Typhon GMOE HH and GMOE (Wired & RF) utilises the gas pressure created by firing a pyrotechnic ignitor to drive a captive, hardened steel spike through an aluminium membrane.

The pyrotechnic ignitor is controlled by programmable electronic circuitry.

The design of Typhon GMOE HH and GMOE (Wired & RF) permits ambidextrous operation.

Typhon GMOE HH and GMOE (Wired & RF) are factory reloadable.

### Typhon GMOE HH Technical Drawing Pack

The technical drawing pack for Typhon GMOE HH is enclosed. Typhon drawing number TYPHON GM0001-2 applies (Page 11 of this document).

### Typhon GMOE (Wired & RF) Technical Drawing Pack

The technical drawing pack for Typhon GMOE follows.

Typhon drawing numbers:

TYPHON GM0001-1, (Page 10 of Drawing Pack document).

TYPHON CB0001-4 (Wired), (Page 12 of Drawing Pack document).

TYPHON CB0001-1 (RF), (Page 13 of Drawing Pack document).

TYPHON CB0001-3 (RF-RX), (Page 14 of Drawing Pack document).

Description

For

TYPHON ZETA and TYPHON ZETA PRACTICE

May 2019

### Introduction

This document describes Typhon Zeta and Typhon Zeta Practice. Typhon Zeta and Typhon Zeta Practice are reloadable, hand thrown electronic distraction devices. Typhon Zeta and Typhon Zeta Practice have been optimised to produce minimal flash, smoke and fragmentation.

Typhon Zeta and Typhon Zeta Practice have been designed and developed by Typhon Group Ltd to fill a niche role for law enforcement, military and government assault teams. They provide a distraction capability that has a very low inherent fire risk. Hence Typhon Zeta can be used in high value target assets and or where there is a significant fire risk. Typhon Zeta Practice is the practice version that has a reduced sound output for training purposes.

Typhon Zeta is used to create temporary distraction and disorientation by emitting five sound impulses. The Typhon Zeta has been optimised to have a low Net Explosive Quantity (NEQ). This feature significantly reduces the inherent fire risk compared to other distraction devices.

The operational version (Typhon Zeta) has a sound output of 170 dB when measured at 2 metres. The practice version (Typhon Zeta Practice) is identical in size and appearance to the operational version and utilises the same technology, however the sound output is reduced to 140 dB when measured at 2 metres.

An important safety feature of Typhon Zeta is that the effect it produces is not considered to cause any long-term injuries to the health of hostages or the CT assault team.

### Technical Details

Typhon Zeta is a non-lethal, reloadable, hand held distraction device. It is manufactured from Aluminium Alloy grade 2011 and has a black anodised finish. The device has outside dimensions of 123.5 mm long by 50.0 mm wide by 22 mm thick. For shipping a plastic safety clip is attached to the device to prevent any unwanted movement of the side-lever release catch. The gross weight of a complete device is 265 g.

Typhon Zeta is powered by a single Lithium Metal Oxide battery. The battery is isolated from the internal circuit by two double pole switches. These switches are controlled by the sprung loaded top catch and the sprung loaded main safety lever. The software in the circuitry monitors the state of the two switches to ensure system integrity. When the device is thrown, both switches change state and apply battery power to the circuit. The circuit controls the device Fuze time. Once this has elapsed, each of the five electro-pyrotechnic fuzes is pre-programmed to initiate at specific time intervals. The action of each fuze firing is to generate gas pressure in each machined port. The gas pressure increases until it ruptures an aluminium membrane and hence creates a sound impulse of 170 dB (measured at 2 metres). Once the device has been initialised it goes into a lock out mode to render it safe, in case any of the electro-pyrotechnic fuzes have failed to function.

Typhon Zeta has programmable functionality that enables the function delay time of the sound impulses to be adjusted to suit the User's preference. This feature is conducted by Typhon Group Ltd prior to product shipment.

Typhon Zeta Practice is identical in size and appearance to the operational version and utilises the same technology. The sound output is optimised to deliver 140 dB when measured at 2 metres from the source. This is achieved by using a reduced energy pyrotechnic ignitor and a reduction in thickness of the aluminium membrane.

A Variant of Typhon Zeta can also be configured to deliver a temporary incapacitation effect in addition to the distraction. To achieve this, a pressed pellet of O-Chlorobenzylidene Malononitrile (CS) is inserted into each of the five ports. The CS cartridge is prevented from initiation on a standard device and requires relevant authority and specific factory programming to enable initiation.

Typhon Zeta can be factory loaded with a fire-retardant powder to further reduce the flash signature and hence lower the flammability risk of the device.

### Initiation

The device is hand thrown. The design of Typhon Zeta enables one handed ambidextrous operation. The User will pull the plastic safety catch from the device and discard it. The User then arms the device by operating a sliding thumb switch. This action releases the sprung loaded top catch. This top catch controls the main power switch for the device, so the device is now effectively ‘switched on’. The User now has two choices. Should they decide to not deploy Typhon Zeta, the device can be made safe by resetting the top catch. However, if the User throws the device it will initiate and function. As the device leaves the User's hand, the main sprung loaded safety lever pivots away from the device body and releases the circuitry arming switch. This starts the device train of operation.

### Novel Design Features of Typhon Zeta

Typhon Zeta utilises a pyrotechnic ignitor to rupture an aluminium membrane to create a sound impulse of around 170 dB when measured at 2 metres.

The pyrotechnic ignitors are controlled by factory programmable electronic circuitry.

The design of Typhon Zeta permits ambidextrous operation.

A practice/training version of Typhon Zeta is available the operation of which is identical to points 54, 55 and 56 above with the exception that the sound impulse is reduced to around 140 dB when measured at 2 metres.

Both Typhon Zeta and Typhon Zeta Practice are factory reloadable.

### Typhon Zeta Technical Drawing Pack

The technical drawing pack for Typhon Zeta is enclosed. Typhon drawing number TYPHON ZE0001-1 applies, (Page 16 of Drawing Pack document).

### Typhon Zeta Practice Technical Drawing Pack

The technical drawing pack for Typhon Zeta Practice is enclosed. Typhon drawing number TYPHON ZE0001-1 applies, (Page 16 of Drawing Pack document).

Description

For

TYPHON SIX and TYPHON SIX PRACTICE

May 2019

### Introduction

This document describes Typhon Six and Typhon Six Practice. Typhon Six and Typhon Six Practice are hand thrown reloadable, electronic distraction devices. Typhon Six and Typhon Six Practice have been optimised to produce minimal flash, smoke and fragmentation.

Typhon Six and Typhon Six Practice have been designed and developed by Typhon Group Ltd to fill a niche role for law enforcement, military and government assault teams. They provide a distraction capability that has a very low inherent fire risk. Hence Typhon Six can be used in high value target assets and or where there is a significant fire risk. Typhon Six Practice is the practice version that has a reduced sound output for training purposes.

Typhon Six is used to create temporary distraction and disorientation by emitting six sound impulses. The Typhon Six has been optimised to have a low Net Explosive Quantity (NEQ). This feature significantly reduces the inherent fire risk compared to conventional distraction devices.

The operational version (Typhon Six) has a sound output of 170 dB per event when measured at 2 metres. The practice version (Typhon Six Practice) is identical in size and appearance to the operational version and utilises the same technology, however the sound output is reduced to 140 dB when measured at 2 metres.

An important safety feature of Typhon Six is that the effect it produces is not considered to cause any long-term injuries to the health of hostages or the CT assault team.

### Technical Details

Typhon Six is a reloadable, non-lethal handheld 6 bang distraction device. It is manufactured from Aluminium Alloy grade 2011 and has a black anodised finish, covered with a label stating the product name. The device has outside dimensions of 124.15 mm height by 44.30 mm diameter. A metal safety clip is attached to the device to prevent any unwanted movement of the fly off lever. The gross weight of a complete device is 350g.

Typhon Six is powered by two CR2 Lithium Batteries. The battery is isolated from the internal circuit by a single double pole switch. This switch is controlled by the sprung loaded main safety lever. The software in the circuitry monitors the state of the switch to ensure system integrity. When the device is thrown, the switch changes state and applies battery power to the circuit. The circuit controls the device throwing time. Once this has elapsed, each of the six electro-pyrotechnic fuzes is pre-programmed to initiate at specific time intervals. The action of each fuze firing is to generate gas pressure in each machined port. The gas pressure increases until it ruptures an aluminium membrane and hence creates a sound impulse of 170 dB (measured at 2 metres) per event. Once the device has been initialised it goes into a lock out mode to render it safe, in case any of the electro-pyrotechnic fuzes have failed to function.

Typhon Six has programmable functionality that enables the function delay time of the sound impulses to be adjusted to suit the User's preference. This feature is conducted by Typhon Group Ltd prior to product shipment.

Typhon Six Practice is identical in size and appearance to the operational version and utilises the same technology. The sound output is optimised to deliver 140 dB per event when measured at 2 metres from the source. This is achieved by using a reduced energy pyrotechnic ignitor and a reduction in thickness of the aluminium membrane.

A variant of Typhon Six can also be configured to deliver a temporary incapacitation effect in addition to the distraction. To achieve this, a pressed pellet of O-Chlorobenzylidene Malononitrile (CS) is inserted into each of the six ports. The CS cartridge is prevented from initiation on a standard device and requires relevant authority and specific factory programming to enable initiation.

Typhon Six can be factory loaded with a fire-retardant powder to further reduce the flash signature and hence lower the flammability risk of the device.

### Initiation

The device is hand thrown. The User pulls the metal pin from the device and discards it (this turns on and arms the device). The fly off lever controls the main power switch for the device. As the device leaves the User's hand, the main sprung loaded safety lever pivots away from the device body and this starts the device train of operation. The device fuze delay is factory programmable to the end user's requirement between 500 ms up to a maximum of 65000 ms.

### Novel Design Features of Typhon Six

Typhon Six utilises six pyrotechnic ignitors to rupture an aluminium membrane to create a sound impulse of around 170 dB per event when measured at 2 metres.

The pyrotechnic ignitors are controlled by factory programmable electronic circuitry.

A practice/training version of Typhon Six is available the operation of which is identical to points 73 and 74 above with the exception that the sound impulse is reduced to around 140 dB per event when measured at 2 metres.

Both Typhon Six and Typhon Six Practice are factory reloadable.

### Typhon Six Technical Drawing Pack

The technical drawing pack for Typhon Six is enclosed. Typhon drawing number TYPHON SIX applies, (Page 18 of Drawing Pack document).

### Typhon Six Practice Technical Drawing Pack

The technical drawing pack for Typhon Zeta Practice is enclosed. Typhon drawing number TYPHON SIX applies, (Page 18 of Drawing Pack document).

1. A non-lethal, modular, software programmable, cable or radio frequency initiated reloadable distraction device utilising an electronically controlled ignitor in machined port(s), to produce gas pressure that ruptures an aluminium membrane creating single or multiple sound impulses to distract/disorientate a target subject.

2. A non-lethal distraction device according to claim 1, in which by varying the gas pressure, sound impulses can be produced between 140 dB (for training scenarios) and 170 dB for operational purposes.

3. A non-lethal distraction device according to claim 1, in which by the inclusion of flame-retardant powder within the machined ports, the likelihood of a sympathetic fire being initiated in hazardous environments is significantly reduced.

4. A non-lethal distraction device according to claim 1, in which by varying the weight and form factor of the casing, the device may be laid down, vehicle mounted, hand-thrown, attached to a drone/Unmanned Aerial System or mounted on a ground based remote controlled robotic system.

5. A non-lethal distraction device according to claim 1, which can also be configured to deliver a temporary incapacitation effect in addition to the distraction by inserting a pressed pellet of O-Chlorobenzylidene Malononitrile (CS) into each of the machined ports.

6. A non-lethal distraction device according to claim 1, which can also be configured as a toughened Glass Method of Entry tool (either Hand Held, Radio Frequency or wired Operation), using the gas pressure created by the ignitor functioning expanding inside the machined port and driving a captive punch forward through an aluminium membrane.

7. A non-lethal distraction device according to claim 1, which may be reloaded in excess of twenty (20) times.

8. A non-lethal distraction device according to claim 1, which can also be configured as a toughened Glass Method of Entry tool (either Hand Held, Radio Frequency or wired Operation), which may also be reloaded in excess of twenty (20) times.
